(19) United States
(12) Patent Application Publication
(10) Pub. No.: US 2026/0024513 A1
(43) Pub. Date: Jan. 22, 2026

(54) BONGO DRUM SUPPORT

(71) Applicant: REMARKABLE Company, Taichung City (TW)

(72) Inventor: Ming Yi Chang, Taichung City (TW)

(21) Appl. No.: 19/074,223

(22) Filed: Mar. 7, 2025

(30) Foreign Application Priority Data
Jul. 17, 2024 (TW) 113207705

(51) Int. Cl. G10G 5/00; G10D 13/10

(52) U.S. Cl. CPC G10G 5/00; G10D 13/10

(57) ABSTRACT

A bongo drum support has an upright shaft. First links are pivotally connected to two opposite sides of an upper end of the upright shaft, respectively. A knob and a sliding sleeve are provided on a lower end of the upright shaft. Second links are pivotally connected to two opposite sides of the sliding sleeve, respectively. The second links extend upward and are pivotally connected to the first links, respectively. A strut is connected to a coupling end of a corresponding one of the first links. An adjustment unit is provided on one end of the strut. The adjustment unit includes a sleeve fitted on the strut and an adjustable restricting member on the sleeve. The restricting member extends radially to form a flange. One side of the flange forms a clamping surface for clamping a bongo drum.

### FIELD OF THE INVENTION

The present invention relates to a support for percussion instruments, and more particularly, to a bongo drum support.

### BACKGROUND OF THE INVENTION

As disclosed in U.S. Pat. No. 7,468,480, a bongo drum support includes brackets welded to the ends of links on two opposite sides of a frame for holding bongos consisting of two connected drums, such that the two drums can be held on the bongo drum support.

However, in the above-mentioned patent, an L-shaped clamp rests against the back of a crossbar between the two drums in one direction. The positioning effect is not ideal. Therefore, when the user strikes the drumhead, the bongos consisting of two connected drums may slide/shift forward, leftward or rightward. Besides, the brackets cannot be adjusted according to different drum sizes. The bongo drum support still has shortcomings.

In addition, the link of the above-mentioned patent is in the form of a flat iron sheet. The end of the link in the form of a flat iron sheet is directly bent and twisted to form a holding surface for holding the bracket. The structural strength of the flat iron sheet will be reduced greatly after being bent and twisted, resulting in insufficient support strength at the joint of the link and the bracket. When the user applies downward force to strike the drumhead, it is prone to shaking, resulting in poor support stability. Furthermore, in the above-mentioned patent, the brackets are welded directly to the links, making it impossible for users to replace brackets with different lengths to fit bongo drums of different sizes. Therefore, the bongo drum support provided by the above-mentioned patent still needs to be improved.

### SUMMARY OF THE INVENTION

The primary object of the present invention is to provide a bongo drum support which can be quickly adjusted according to different drum sizes while ensuring that bongo drums of different sizes can be positioned stably, without slipping.

Another object of the present invention is to provide a bongo drum support which has excellent support strength and enhances its stability effectively when subjected to force.

In order to achieve the foregoing objects, the present invention provides a bongo drum support. The bongo drum support comprises an upright shaft. The upright shaft has an upper end and a lower end. First links are pivotally connected to two opposite sides of the upper end, respectively. A knob and a sliding sleeve located above the knob are provided on the lower end. The knob is threadedly connected to the lower end. The sliding sleeve is pushed to move in an axial direction of the upright shaft by rotating the knob. Second links are pivotally connected to two opposite sides of the sliding sleeve, respectively. The second links extend upward and are pivotally connected to the first links, respectively. The first links each have two ends defined as a pivot end and a coupling end opposite to the pivot end. The pivot ends of the first links are pivotally connected to the two opposite sides of the upper end, respectively. A strut is connected to the coupling end of a corresponding one of the first links. The strut is perpendicular to and intersected with the corresponding first link and extends in a front direction and in a rear direction.

An adjustment unit is provided on at least one end of the strut. The adjustment unit includes a sleeve fitted on the strut and a restricting member connected on an outer circumference of the sleeve. The restricting member is adjustable and movable to be positioned on the sleeve. The restricting member extends radially to form a flange. One side of the flange, facing the corresponding first link, forms a clamping surface.

Furthermore, the first links each have a link body in the form of a flat plate. The link body has two ends defined as a pivot end and a coupling end opposite to the pivot end. The pivot ends of the first links are pivotally connected to the two opposite sides of the upper end. The coupling end of each of the first links is bent back toward the pivot end to form a U shape and has a first bent section which is generally perpendicular to the link body and a second bent section which is generally parallel to the link body. The second bent section and the link body opposite to the second bent section are formed with perforations that are arranged symmetrically. A strut is inserted through the perforations of the second bent section and the link body so that the strut is detachably connected to a corresponding one of the first links.

### BRIEF DESCRIPTION OF THE DRAWINGS

FIG. 1 is a perspective view according to a first embodiment of the present invention;

FIG. 2 is another perspective view according to the first embodiment of the present invention;

FIG. 3 is a schematic view according to the first embodiment of the present invention;

FIG. 4 is a front schematic view according to the first embodiment of the present invention in a use state;

FIG. 5 is a top schematic view according to the first embodiment of the present invention in a use state;

FIG. 6 is a schematic view according to the first embodiment of the present invention in another use state; and

FIG. 7 is a perspective view according to a second embodiment of the present invention.

### DETAILED DESCRIPTION OF THE PREFERRED EMBODIMENTS

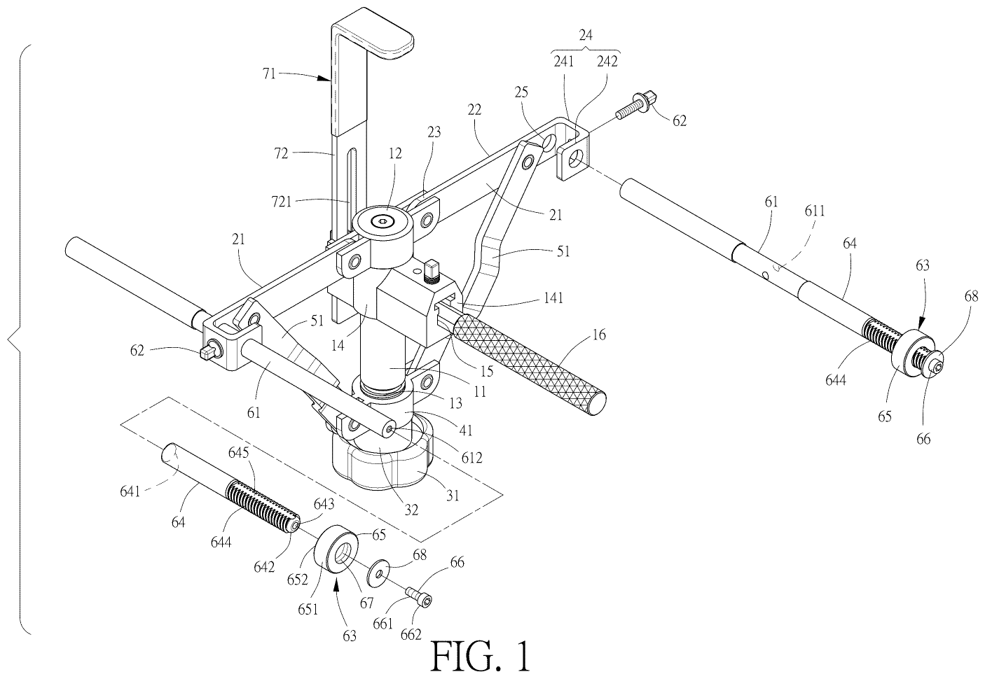

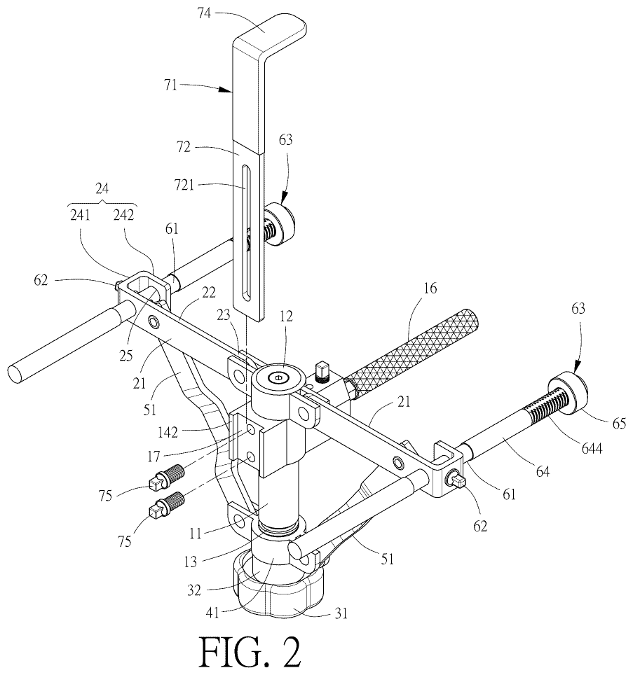

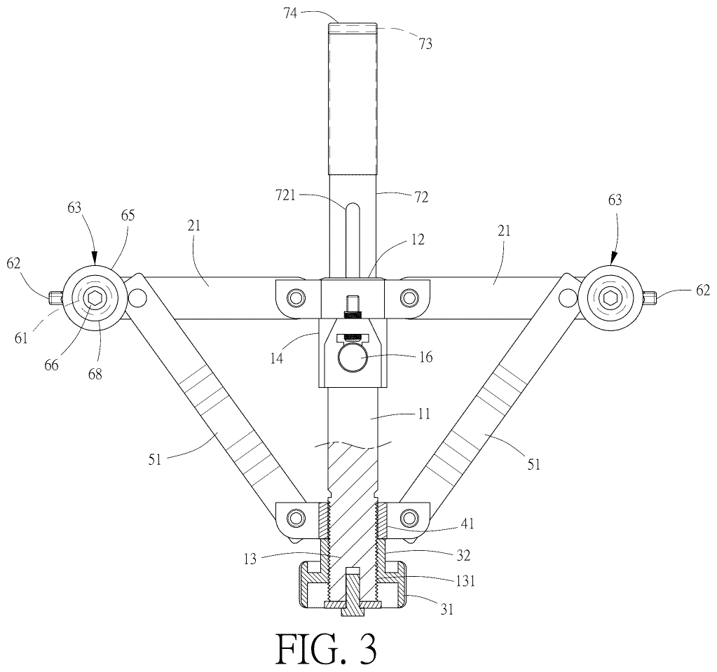

As shown in FIG. 1 through FIG. 3, a bongo drum support according to a first embodiment of the present invention comprises an upright shaft 11 extending in a vertical direction. The upright shaft 11 has an upper end 12 and a lower end 13. First links 21 are pivotally connected to two opposite sides of the upper end 12, respectively. A knob 31 and a sliding sleeve 41 located above the knob 31 are provided on the lower end 13. The knob 31 is threadedly connected to an outer threaded section 131 of the lower end 13. The sliding sleeve 41 is slidably fitted on the outer periphery of the lower end 13. The sliding sleeve 41 is in contact with a push portion 32 extending upward from the knob 31. Second links 51 are pivotally connected to two opposite sides of the sliding sleeve 41, respectively. The second links 51 extend upward and are pivotally connected to the first links 21, respectively. When the knob 31 is rotated to move along the outer threaded section 131, the sliding sleeve 41 is pushed to move in the axial direction of the upright shaft 11, and then the second links 51 pivoted to the sliding sleeve 41 drive the first links 21 to perform a pivoting motion.

Furthermore, the first links 21 each have a link body 22 in the form of a flat plate. The link body 22 has two ends defined as a pivot end 23 and a coupling end 24 opposite to the pivot end 23. The pivot ends 23 of the first links 21 are pivotally connected to the two opposite sides of the upper end 12. The coupling end 24 of each of the first links 21 is bent back toward the pivot end 23 to form a U shape and has a first bent section 241 which is generally perpendicular to the link body 22 and a second bent section 242 which is generally parallel to the link body 22. The second bent section 242 and the link body 22 opposite to the second bent section 242 are formed with perforations 25 that are arranged symmetrically. A strut 61 is inserted through the perforations 25 of the second bent section 242 and the link body 22 so that the strut 61 is perpendicular to and intersected with the corresponding first link 21 and extend in a front direction and in a rear direction. A locking member 62 passes through the first bent section 241 and is screwed to a screw hole 611 of the strut 61, such that the strut 61 is detachably connected to the corresponding first link 21. An adjustment unit 63 is provided on the front end of the strut 61. The adjustment unit 63 includes a sleeve 64 fitted on the strut 61 and a restricting member 65 connected on the outer circumference of the sleeve 64. The restricting member 65 is adjustable and movable to be positioned on the sleeve 64. The restricting member 65 extends radially to form a flange 651. One side of the flange 651, facing the corresponding first link 21, forms a clamping surface 652.

In the first embodiment, one end of the sleeve 64 is recessed to form a sleeve hole 641 extending in the axial direction of the sleeve 64. The other end of the sleeve 64 forms an abutting surface 642. The sleeve 64 is fitted on the strut 61 via the sleeve hole 641. The abutting surface 642 abuts against the end of the strut 61. The abutting surface 642 of the sleeve 64 has a through hole 643. The end of the strut 61 has another screw hole 612 corresponding in position to the through hole 643. A screw 66 passes through the through hole 643 and is locked to the screw hole 612, so that the sleeve 64 is positioned on the strut 61. The outer circumference of the sleeve 64 has an outer threaded section 644. The restricting member 65 is annular and has an inner circumferential surface. An inner threaded section 67 is formed on the inner circumferential surface. The inner threaded section 67 of the restricting member 65 is threadedly connected to the outer threaded section 644 of the sleeve 64, such that the restricting member 65 is adjustable and movable in the axial direction of the sleeve 64. The outer threaded section 644 of the sleeve 64 has a flat support side 645 that is formed by cutting the top of the outer threaded section 644. The screw 66 has a threaded portion 661 and a head 662 having an outer diameter greater than that of the threaded portion 661. The threaded portion 661 of the screw 66 is locked in the screw hole 612. A washer 68 is provided between the head 662 of the screw 66 and the abutting surface 642 of the sleeve 64. The outer diameter of the washer 68 is greater than the outer diameter of the sleeve 64, so as to prevent the restricting member 65 from coming out of the sleeve 64 when adjusting its threaded position.

Furthermore, a support block 14 is fixedly connected to the upper end 12 of the upright shaft 11. The support block 14 has a front side 141 and a rear side 142. The front side 141 has a coupling hole 15. A bar 16 extending forward is insertedly connected to the coupling hole 15. The rear side 142 has a longitudinal groove 17. An L-shaped clamping member 71 is connected to the longitudinal groove 17. The L-shaped clamping member 71 has an upright section 72 and a pressing section 73 that is perpendicular to the upright section 72 and extends toward the front side 141. The pressing section 73 of the L-shaped clamping member 71 is sleeved with an L-shaped protective cover 74 extending to the upright section 72. The L-shaped protective cover 74 is made of soft material, having a shock-absorbing function. The upright section 72 has a longitudinal slot 721. The upright section 72 of the L-shaped clamping member 71 is inserted in the longitudinal groove 17. A plurality of locking members 75 pass through the longitudinal slot 721 for locking the upright section 72 in the longitudinal groove 17. The locking position of the L-shaped clamping member 71 can be changed via the longitudinal slot 721, thereby adjusting the clamping height of the L-shaped clamping member 71.

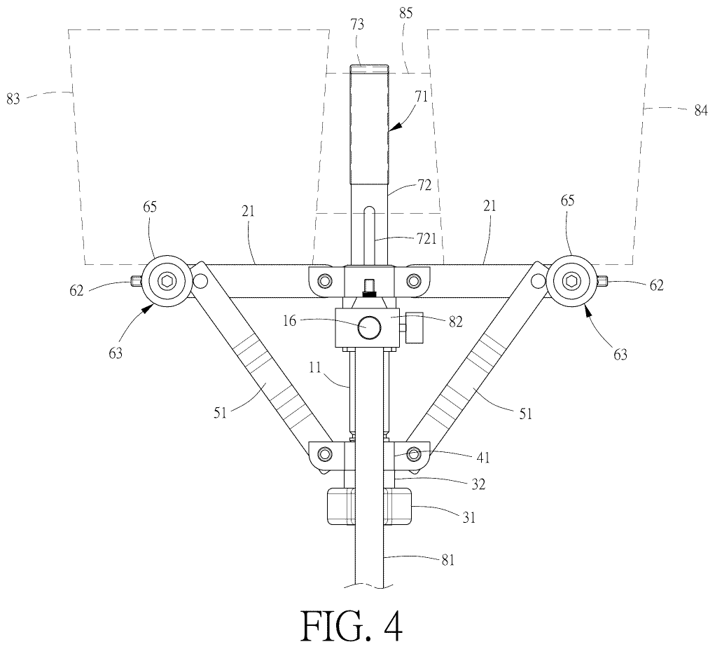

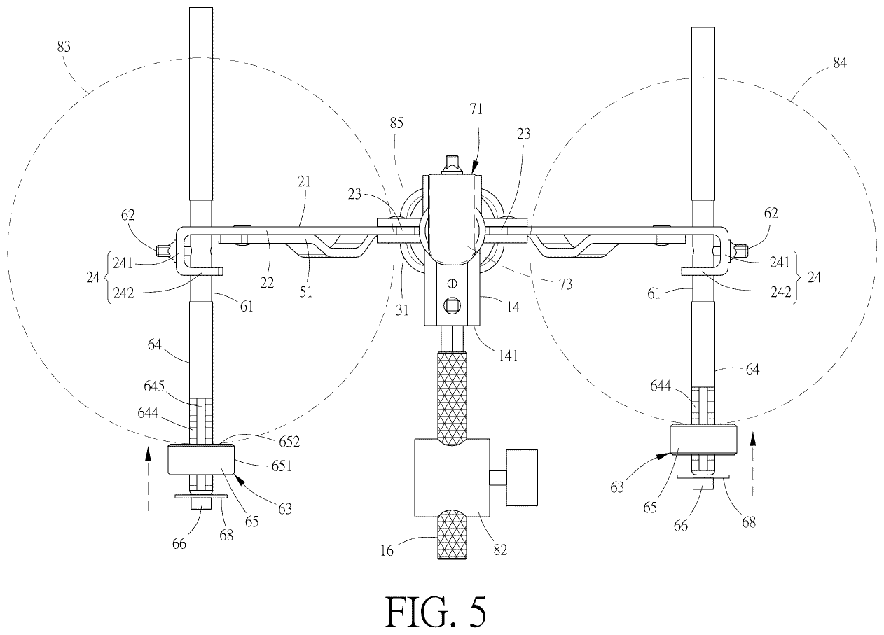

Referring to FIG. 4 and FIG. 5, in actual use, after the bar 16 is insertedly connected to a connecting seat 82 of a stand 81, the drum bodies 83, 84 of two bongo drums are placed on the two first links 21 and the struts 61, respectively, and the pressing section 73 of the L-shaped clamping member 71 is pressed against a crossbar 85 connecting the drum bodies 83, 84 of the two bongo drums. Then, according to the size of the drum bodies 83, 84, the positions of the restricting members 65 on the struts 61 are adjusted manually for the clamping surfaces 652 on the flanges 651 of the restricting members 65 to clamp the front sides of the drum bodies 83, 84, respectively. The two drum bodies can be positioned on the struts 61 stably by the L-shaped clamping member 71 and the restricting members 65. The bongo drum support provided by the present invention can be adjusted quickly and ensures that bongo drums of different sizes can be positioned stably, without slipping. The user can rotate the knob 31 to drive the second links 51 to push the first links 21 to generate a corresponding pivoting motion, thereby synchronously moving the bongo drums up and down, allowing for height adjustment to meet the striking habits of different drummers.

Besides, in the present invention, the coupling end 24 of each first link 21 is bent toward the pivot end 23 to form a U-shaped configuration, which enables the coupling end 24 to have better structural strength. The strut 61 is inserted through the perforations 25 of the second bent section 242 and the link body 22, so that the strut 61 can be supported by the link body 22 of the first link 21 and the second bent section 242, thereby having better support performance. This can effectively reduce the shaking caused by the drummer's strikes and provide better support stability. Furthermore, the strut 61 of the present invention is directly inserted through the coupling end 24 and then connected to the first link 21 by means of the locking member 62. Therefore, the user can remove the strut 61 from the first link 21 by unscrewing the locking member 62, such that the user can replace a desired strut 61 with a different length in a simple and fast manner. By adjusting the clamping height of the L-shaped clamping member 71, the bongo drum support provided by the present invention can be used for bongo drums of various sizes.

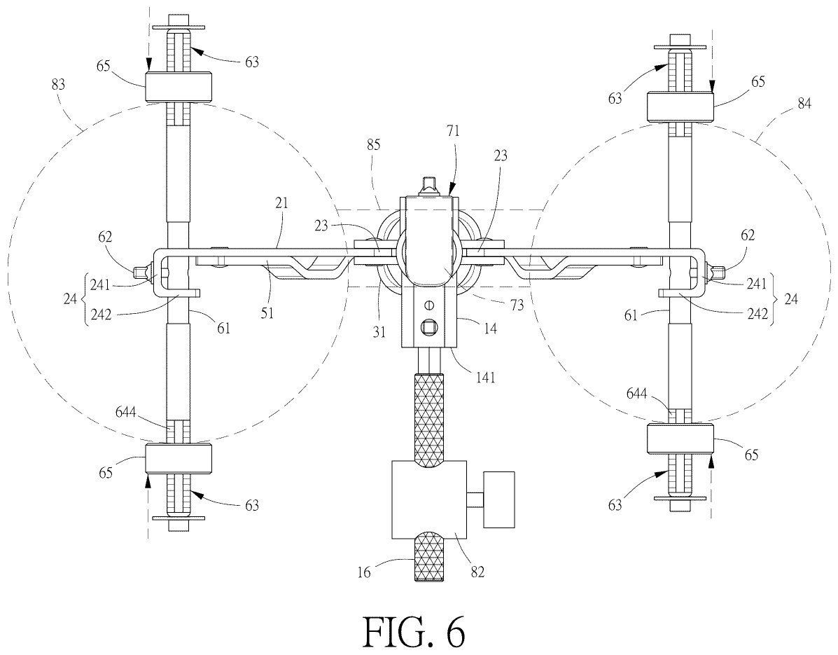

As shown in FIG. 6, in practical application, both ends of each strut 61 of the present invention are provided with the adjustment units 63 which are arranged symmetrically, thereby ensuring the stability of the two drum bodies clamped by the restricting members 65 on the front and rear ends of the struts 61.

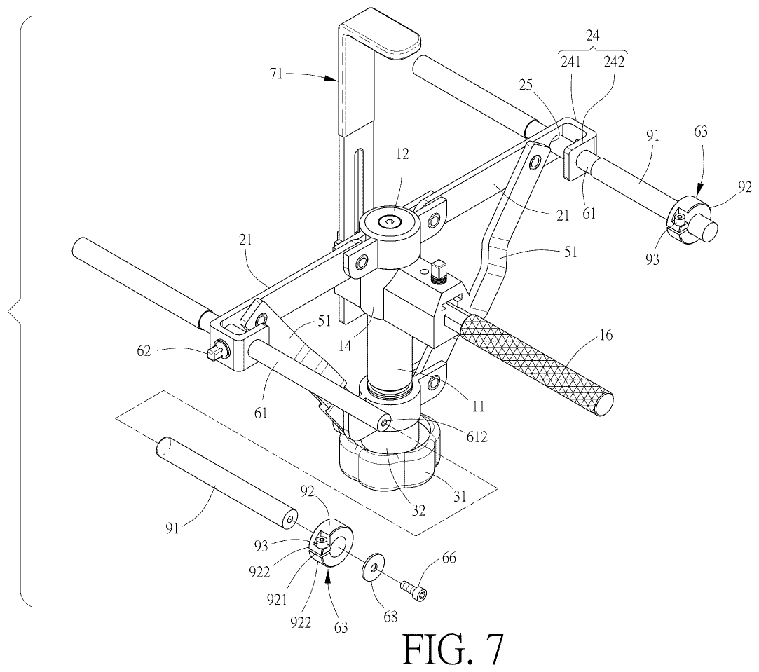

FIG. 7 illustrates a second embodiment of the bongo drum support provided by the present invention. The second embodiment is substantially similar to the first embodiment with the exceptions described hereinafter. The adjustment unit 63 is composed of a sleeve 91 and a restricting member 92. In the second embodiment, the outer circumference of the sleeve 91 is smooth, and the restricting member 92 is in the form of a C-shaped fastening ring around the outer circumference of the sleeve 91. The restricting member 92 has an opening 921 and two coupling portions 922 that are formed on two ends of the opening 921 and spaced apart from each other. A locking member 93 is configured for locking the two coupling portions 922 so that the restricting member 92 is locked and positioned on the sleeve 91. Before the locking member 93 locks the two coupling portions 922, the restricting member 92 can slide along the outer circumference of the sleeve 91 for adjusting its locking position. According to different drum sizes, the locking position of the restricting member 92 can be adjusted quickly. The front sides of the bongo drums are clamped by the restricting members 92, thereby providing a stable positioning effect for the bongo drums.

What is claimed is:

1. A bongo drum support, comprising an upright shaft, the upright shaft having an upper end and a lower end, first links being pivotally connected to two opposite sides of the upper end respectively, a knob and a sliding sleeve located above the knob being provided on the lower end, the knob being threadedly connected to the lower end, the sliding sleeve being pushed to move in an axial direction of the upright shaft by rotating the knob, second links being pivotally connected to two opposite sides of the sliding sleeve respectively, the second links extending upward and being pivotally connected to the first links respectively, the first links each having two ends defined as a pivot end and a coupling end opposite to the pivot end, the pivot ends of the first links being pivotally connected to the two opposite sides of the upper end respectively, a strut being connected to the coupling end of a corresponding one of the first links, the strut being perpendicular to and intersected with the corresponding first link and extending in a front direction and in a rear direction, characterized in that:
an adjustment unit is provided on at least one end of the strut, the adjustment unit includes a sleeve fitted on the strut and a restricting member connected on an outer circumference of the sleeve, the restricting member is adjustable and movable to be positioned on the sleeve, the restricting member extends radially to form a flange, and one side of the flange, facing the corresponding first link, forms a clamping surface.

2. The bongo drum support as claimed in claim 1, wherein one end of the sleeve is recessed to form a sleeve hole extending in an axial direction of the sleeve, another end of the sleeve forms an abutting surface, the sleeve is fitted on the strut via the sleeve hole, and the abutting surface abuts against the end of the strut.

3. The bongo drum support as claimed in claim 2, wherein the abutting surface of the sleeve has a through hole, the end of the strut has a screw hole corresponding in position to the through hole, and a screw passes through the through hole and is locked to the screw hole so that the sleeve is positioned on the strut.

4. The bongo drum support as claimed in claim 3, wherein the screw has a threaded portion and a head having an outer diameter greater than that of the threaded portion, the threaded portion of the screw is locked in the screw hole, a washer is provided between the head of the screw and the abutting surface of the sleeve, and the washer has an outer diameter greater than that of the sleeve.

5. The bongo drum support as claimed in claim 4, wherein the outer circumference of the sleeve has an outer threaded section, the restricting member is annular and has an inner circumferential surface, an inner threaded section is formed on the inner circumferential surface, and the inner threaded section of the restricting member is threadedly connected to the outer threaded section of the sleeve so that the restricting member is adjustable and movable in the axial direction of the sleeve.

6. The bongo drum support as claimed in claim 5, wherein the outer threaded section of the sleeve has a flat support side that is formed by cutting a top of the outer threaded section.

7. The bongo drum support as claimed in claim 4, wherein the restricting member is in the form of a C-shaped fastening ring around the outer circumference of the sleeve, the restricting member has an opening and two coupling portions that are formed on two ends of the opening and spaced apart from each other, and a locking member is configured for locking the two coupling portions so that the restricting member is locked and positioned on the sleeve.

8. A bongo drum support, comprising an upright shaft, the upright shaft having an upper end and a lower end, first links being pivotally connected to two opposite sides of the upper end respectively, a knob and a sliding sleeve located above the knob being provided on the lower end, the knob being threadedly connected to the lower end, the sliding sleeve being pushed to move in an axial direction of the upright shaft by rotating the knob, second links being pivotally connected to two opposite sides of the sliding sleeve respectively, the second links extending upward and being pivotally connected to the first links respectively, characterized in that:
the first links each have a link body in the form of a flat plate, the link body has two ends defined as a pivot end and a coupling end opposite to the pivot end, the pivot ends of the first links are pivotally connected to the two opposite sides of the upper end, the coupling end of each of the first links is bent back toward the pivot end to form a U shape and has a first bent section which is generally perpendicular to the link body and a second bent section which is generally parallel to the link body, the second bent section and the link body opposite to the second bent section are formed with perforations that are arranged symmetrically, and a strut is inserted through the perforations of the second bent section and the link body so that the strut is detachably connected to a corresponding one of the first links.

9. The bongo drum support as claimed in claim 8, wherein a support block is fixedly connected to the upper end of the upright shaft, the support block has a front side and a rear side, the front side has a coupling hole, a bar extending forward is insertedly connected to the coupling hole, the rear side has a longitudinal groove, an L-shaped clamping member is connected to the longitudinal groove, the L-shaped clamping member has an upright section and a pressing section that is perpendicular to the upright section and extends toward the front side, the upright section has a longitudinal slot, the upright section of the L-shaped clamping member is inserted in the longitudinal groove, and a plurality of locking members pass through the longitudinal slot for locking the upright section in the longitudinal groove.

10. The bongo drum support as claimed in claim 9, wherein the pressing section of the L-shaped clamping member is sleeved with an L-shaped protective cover extending to the upright section.
